(19) United States
(12) Patent Application Publication
(10) Pub. No.: US 2005/0041120 A1
(43) Pub. Date: Feb. 24, 2005

(54) System and method for retrieving audio information from a captured image

(76) Inventor: Casey Lee Miller, Fort Collins (CO)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/643,242

(22) Filed: Aug. 18, 2003

(51) Int. Cl. H04N 5/262; H04N 1/40

(52) U.S. Cl. 348/239; 348/231.4; 358/3.28

(57) ABSTRACT

The present invention provides a system and method for retrieving audio information with a digital camera. Briefly described, one embodiment comprises capturing an image of a bar code with the digital camera, determining audio information corresponding to the captured image of the bar code with the digital camera, and generating an audible sound corresponding to the determined audio information with an audio reproduction device residing in the digital camera.

### TECHNICAL FIELD

The present invention is generally related to digital imagery and related audio information, more particularly, is related to a system and method for retrieving audio information from a captured image of a bar code.

### BACKGROUND

Digital cameras may capture audio recordings that are associated with still images and/or video clips. Video clips are series of time-related captured images that appear as a moving image when viewed, much like a movie. When video clips having associated audio recording data are played back after capture, both the video clip and the associated audio recordings are typically played back together. Play-back devices can play back audio clips stored in an electronic format include a variety of devices, such as the image capture device itself, other compatible image capture devices, personal computers, televisions and other types of graphical display devices.

Still images, which represent a visual image captured at a single instant of time, may also have an audio clip that is associated with the still image. The audio clip, when played while viewing the still image, typically provides the viewer with additional information concerning the still image.

A still image may be viewed on one of the above-described play-back devices, or may be printed on a hard-copy media. When viewed on a play-back device, the associated audio clip may be played back while the viewer is viewing the still image only if the audio clip is stored in an electronic format accessible to the playback device. However, if the still image is printed as a hard-copy media print, there is no convenient way for the audio clip to be played back when the viewer is viewing the hard-copy image.

Typically, still images may be communicated to third parties or other devices electronically. That is, both the captured digital image data and the associated audio clip data are communicated together as a single data unit or as associated data units. Thus, when a third party wishes to view the image and listen to the audio clip, the image and audio data are played back using a suitable play-back device.

If the still image is printed as a hard-copy media print, audio recordings may be sent with the hard-copy image print if the digital audio clip data is saved onto a separate suitable memory medium, like a floppy disk, magnetic devices, flash memory card, compact disk (CD) or the like. Such memory medium may be expensive to acquire, may increase the cost of sending the image and audio clip (increased postal and packaging costs), may be difficult to transport without damage, and may require a suitable play-back device to access the audio recording data.

Various techniques have been employed to attach or transmit associated audio clips with a hardcopy still image print. One technique involves embedding a magnetic chip or other memory medium into the print medium itself. However, a suitable reader is required to retrieve the digital audio clip data from the magnetic chip or other memory medium.

Another technique converts the audio recording data into a printable format, such as a bar code or other suitable code, that is printed directly onto the print of the still image using an ink that is not visible to the human eye. However, such a technique requires a printer having the specialized ink, requires significant processing time to properly prepare the printing data, and requires a special device to read the non-visible ink. Also, the quality of the still image may suffer due to the applied non-visible ink.

Another technique converts the audio clip data into a printable format, such as a bar code or other suitable code, that is printed with the image using visible ink. The printed bar code is printed on the border, over a selected region of the image, on the backside of the print media on which the image is printed, or on a separate sheet of medium. However, such a technique requires a separate bar code reading device to read the bar code, a processor for converting the bar code data back into audio information, and a speaker to generate the audio sound.

### SUMMARY

The present invention provides a system and method for retrieving audio information with a digital camera. Briefly described, one embodiment comprises capturing an image of a bar code with the digital camera, determining audio information corresponding to the captured image of the bar code with the digital camera, and generating an audible sound corresponding to the determined audio information with an audio reproduction device residing in the digital camera.

Another embodiment comprises a photosensor to capture an image of a bar code comprising audio information, a processor to determine audio information from the captured image of the bar code, and a speaker to generate audible sound corresponding to the determined audio information.

### BRIEF DESCRIPTION OF THE DRAWINGS

The components in the drawings are not necessarily to scale relative to each other. Like reference numerals designate corresponding parts throughout the several views.

FIG. 1 is a block diagram of selected components of an image capture device having an embodiment of the still image audio clip processing system.

FIG. 2 is a block diagram illustrating an embodiment of a still image audio clip processing system.

FIG. 3 illustrates a printed captured image and printed exemplary audio clip bar codes prepared by embodiments of the still image audio clip processing system.

FIG. 4 is a flowchart illustrating an embodiment of a process for retrieving audio information from an audio clip bar code.

FIG. 5 is a flowchart illustrating an embodiment of a process for generating an audio clip bar code from recorded audible sounds.

### DETAILED DESCRIPTION

Embodiments of the still image audio clip processing system 100 allow a user to capture an image of a bar code having audio information. The audio information is played back on a speaker residing in the digital camera so that the user may hear the audio information. For example, but not by way of limitation, the audio information may relate a picture of an object and a printed bar code, the bar code having audio information imparting information about the object which may be viewed by the user. The user can capture an image of the bar code with an image capture device having an embodiment of the still image audio clip processing system 100, and then hear the audio information about the object while viewing the picture of the object.

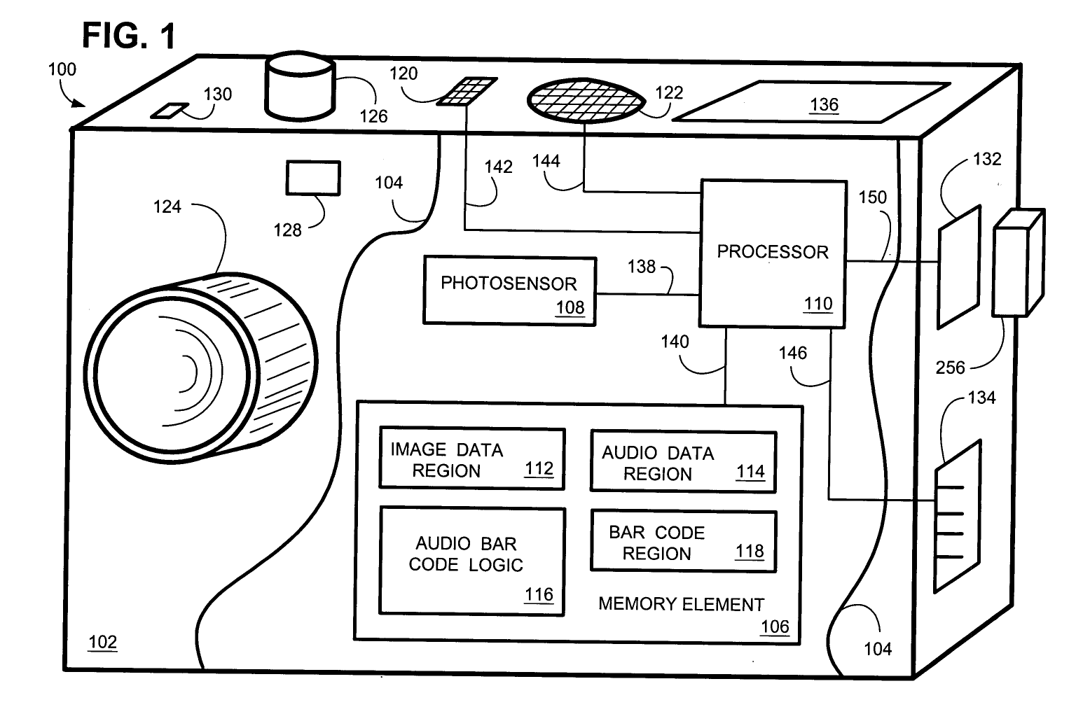

FIG. 1 is a block diagram of selected components of an image capture device 102 having an embodiment of the still image audio clip processing system 100. FIG. 1 illustrates selected external and internal components of digital camera 102, demarked by cut-away lines 104. The internal components, shown between cut-away lines 104, include at least memory element 106, photosensor 108 and processor 110. In one embodiment, memory element 106 includes camera image data region 114 for storing image data corresponding to still visual images, audio data region 112 for storing audio data associated with the still visual images, and audio bar code logic 116. Another embodiment has an optional bar code data region 118 for storing prepared bar codes associated with audio clips.

The exemplary embodiment of the image capture device, illustrated as digital camera 102, includes at least a microphone 120, a speaker 122, a lens unit 124, an image capture actuation button 126, a viewing lens 128, a power switch 130, memory unit interface 132 and/or a plug-in communication interface 134, and display 136. Speaker 122 is any suitable electro-audio transducer or audio reproduction device that generates audible sound that is discernable to a listener. Microphone 120 is any suitable electro-audio transducer or audio detection device that detects sound, and then generates electronic information corresponding to the detected sound. Display 136 is any suitable device used for previewing still images prior to capturing or for viewing captured still visual images. For convenience, display 136 is illustrated on the top of digital camera 102.

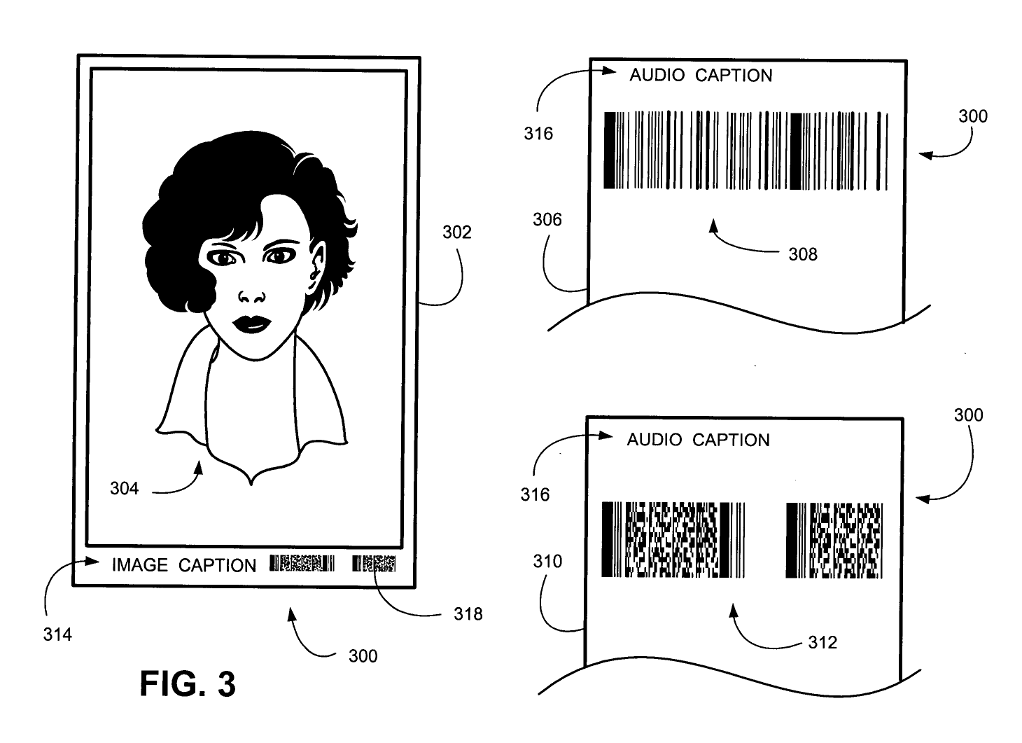

Operation of digital camera 102 is initiated by actuation of power switch 130 or an equivalent device to apply power to component parts of the digital camera 102. Digital camera 102 is used to capture an image of a printed bar code corresponding to an audio clip having audio information, described in greater detail below. After capturing an image of the audio clip bar code 300 (FIG. 3), audio information in the bar code 300 is played back over speaker 122 as audible sound. Thus, a viewer viewing a still visual image on display 136, or viewing a still visual image on a hard-copy media, may concurrently listen to the audio clip corresponding to that still visual image by listening to the audio information broadcasted from speaker 122.

Prior to capturing an image of the audio clip bar code 300, the operator of digital camera 102 may visually preview the image of the audio clip bar code 300 on display 136. Or, audio clip bar code 300 may be viewed directly through viewing lens 128. Photosensor 108 is disposed in a suitable location behind lens unit 124 such that an image of an audio clip bar code 300 may be focused onto photosensor 108 for capturing. When the operator has focused the image of audio clip bar code 300 and is satisfied with the focused image, the operator actuates image capture actuation button 126 (also referred to as a shutter button or a shutter release button) to cause digital camera 102 to capture the image of audio clip bar code 300. Photosensor 108 detects the image of audio clip bar code 300 through lens unit 124 and communicates digital image data corresponding to detected audio clip bar code 300 to camera processor 110, via connection 138.

The received image data corresponding to audio clip bar code 300 is processed into digital audio clip data when processor 110 executes audio bar code logic 116. The digital audio clip data corresponding to captured audio clip bar code 300 is stored to bar code data region 118 of memory element 106, via connection 140.

Some embodiments of digital camera 102 capture visual images and also record audio clips that are associated with the captured visual image. When a visual image is captured, the digital camera may also be used to record an audio clip with microphone 120. Sound information is communicated to processor 110, via connection 142, and is processed into an audio clip. Logic to process the received sound information into an audio clip, and to store digital audio clip data into audio clip data region 114, may be included as separate logic or be incorporated onto audio bar code logic 116. The process includes associating the audio clip with the captured visual image using any suitable means.

After capturing a visual image and an associated audio clip, the operator of digital camera 102 may view the captured visual image on display 136 and play back the audio clip over speaker 122, communicated to speaker 122 via connection 144. Accordingly, image data region 112 may store many captured visual images 310 and audio data region 114 may store many associated audio clips.

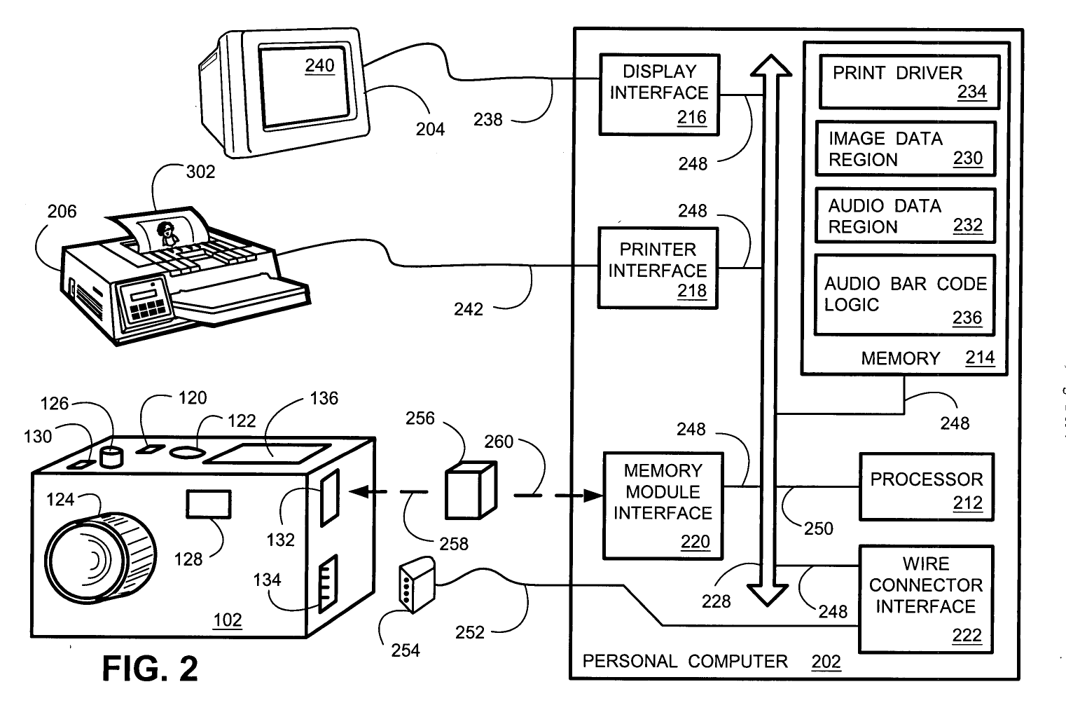

FIG. 2 is a block diagram illustrating an embodiment of a still image audio clip processing system 100 in digital camera 102, along with a personal computer 202, a display 204 and a printing device 206. Personal computer 202 is employed with digital camera 102 such that digital images and associated sound clips captured by digital camera 102 may be retrieved, processed and/or printed.

An exemplary embodiment of personal computer 202 includes a processor 212, a memory 214, a display interface 216, a printer interface 218, a memory module interface 220, a wire connector interface 222 and a communication bus 228. Memory 214 includes an image data region 230 where at least one captured visual image resides, an audio data region 232 where information corresponding to associated audio clips reside, a print driver 234, and audio bar code logic 236. Memory 214 may also contain other data, logic and/or information used in the operation of personal computer 202.

Personal computer 202 is illustrated as being coupled to display 240, via connection 238, so that captured images can be viewed on display 240. Personal computer 202 is illustrated as being coupled to printer 206, via connection 242, so that audio clip bar code 300 may be printed.

Memory 214, display interface 216, printer interface 218, memory module interface 220 and wire connector interface 222 are coupled to communication bus 228 via connections 248. Communication bus 228 is coupled to processor 212 via connection 250, thereby providing connectivity to the above-described components. In alternative embodiments of personal computer 120, the above-described components are connectivley coupled to processor 212 in a different manner than illustrated in FIG. 2. For example, one or more of the above-described components may be directly coupled to processor 212 or may be coupled to processor 212 via intermediary components.

In one embodiment of digital camera 102, digital camera 102 transfers captured visual images and associated digital audio image clips to personal computer 202 via a hard wire connection 252. Connection 252 is coupled to a plug-in attachment 254. Plug-in attachment 254 connects to plug-in communication interface 134. The user simply connects plug-in attachment 254 to plug-in communication interface 134 thereby establishing connectivity between digital camera 102 and personal computer 202. The user then instructs personal computer 202 and/or digital camera 102 to transfer digital image data and associated digital audio image clips from digital camera 102 into image data region 230 and audio data region 232, respectively.

In another embodiment, digital visual image data and associated digital audio image clips are stored in memory module unit 256. When capturing images and associated digital audio image clips with digital camera 102, memory module unit 256 is coupled to digital camera 102 through memory unit interface 132, as illustrated by dashed line path 258. As the user of digital camera 102 actuates image capture actuation button 126 to cause camera processor 110 to capture the current image detected by photosensor 108, camera processor 110 communicates the digital image data to memory module unit 256, via connection 150 (FIG. 1) and memory unit interface 132.

Digital camera 102 may concurrently record an audio clip with a visual image by detecting sound with microphone 120. Or, an audio clip may be later recorded, depending upon the embodiment of digital camera 102. Digital camera 102 may include other actuators to control the recording of an audio clip and for associating the recorded audio clip with a selected captured image. Such a system may also be implemented, in part or in whole, using a menu displayed on display 136.

Accordingly, memory module unit 256 may store images and/or associated audio clips. Digital image data and associated digital audio image clips are transferred to personal computer 202 by removing memory module unit 256 from digital camera 102, and then coupling memory module unit 256 to memory module interface 220. Typically, a convenient coupling port or interface is provided on the surface of personal computer 202 such that memory module unit 256 is directly coupled to personal computer 202, as illustrated by dashed line path 260. Once memory module unit 256 is coupled to memory module interface 220, digital image data and associated digital audio image clips from digital camera 102 are transferred into image data region 230 and audio data region 232, respectively.

For convenience, digital camera 102 is described above as employing both a memory element 112 and a memory module unit 256 to store captured images and audio clips. Typically, digital camera 102 would, in practice, employ either memory element 112 or memory module unit 256 to store captured images and audio clips because employing two different and separate memory systems would be inefficient and costly. (However, some embodiments of a digital camera 102 employ both a memory element 112 and a memory module unit 256.)

Once captured images and audio clips are transferred from digital camera 102 to personal computer 202, an audio clip bar code 300 (FIG. 3) may be prepared by executing audio bar code logic 236. FIG. 3 illustrates a printed captured visual image 302 and printed exemplary audio clip bar codes prepared by embodiments of the still image audio clip processing system 100.

Printed image 302 illustrates an image 304 of a lady. Printed image 306 illustrates a plurality of one dimensional (1-D) audio clip bar codes 308. Printed image 310 illustrates a two dimensional (2-D) audio clip bar code 312. The printed images 302, 306 and 310 may be printed by printer 206 (FIG. 2) or any other suitable printing device.

Audio clip bar codes 300 may represent large amounts of audio data based upon position of bars, and corresponding blank regions between the bars, on printed audio clip bar code 300. The 1-D audio clip bar codes 308 employ a plurality of lines or bars, wherein the frequency and/or thickness of a line or bar, and the corresponding blank regions between the bars, corresponds to information. The 2-D audio clip bar code 312 similarly employs a plurality of lines or bars wherein the frequency, length and/or thickness of a line or bar corresponds to information. However, with a 3-D audio clip bar code 312, a plurality of lines or bars may also be printed on a single column such that the size and positioning of multiple lines or bars in a single column further corresponds to information. Accordingly, more information may be stored using a 2-D format. A three dimensional (3-D) format may also be used. A 3-D format employs a plurality of colors to color-code the lines and/or blank regions, thereby increasing the amount of information storage capacity, such that the coloring, size and positioning of the lines or bars further corresponds to information. Embodiments may operate with any suitable format used to prepare and/or print an audio clip bar code 300, 308 and/or 312.

In one embodiment, printed image 302 includes text caption 314 that imparts information relating to the nature of the visual image 302. Text caption 314 may aid the viewer in associating printed visual image 302 with corresponding printed audio clip bar codes 308 or 312. For example, text caption 314 may state that the captured image 304 of the lady is “Mary at Work” or some other suitable descriptive text. Text caption 314 may include other information of interest, such as date, time and/or location of image capture. Embodiments of printed images 306 or 310 may include their own text caption 316 that imparts information relating to the nature of the audio information of the audio clip bar codes 308 and/or 312. Captions 314 and 316 may be identical, or may vary, so long as a viewer is able to understand that printed image 302 corresponds to one or more of the printed images 306, 310. Captions 314 and 316 may be prepared in any suitable manner, such as by logic residing in personal computer 202 or by logic residing in digital camera 102, and may be saved into a suitable memory for later retrieval and/or printing with its corresponding captured image.

If the audio clip contains a sufficiently small amount of information, the audio information may be printed on the image itself, as shown by the audio clip bar code 318 printed on the border of the printed image 304 of the lady. The audio clip bar code 318 may be printed on any desirable location on printed image 302. If the amount of audio information is sufficiently large, audio clip bar codes 318 may be printed on one or more separate sheets of paper. Or, audio clip bar codes may be printed on the back side of image 302. Thus, audio information, in the form of a audio clip bar code, may be conveniently printed in a hard copy format and be kept with printed image 302.

Once a viewer has associated printed image 302 with one of the printed images 306 and/or 310 having printed audio clip bar codes 300, digital camera 102 is used to obtain audio information from the printed audio clip bar codes 300 associated with printed image 302. The user of digital camera 102 captures an image of printed images 306 and/or 310 having printed audio clip bar codes 300. Image data corresponding to printed audio clip bar codes 300 is communicated to processor 110. Audio bar code logic 116 is executed so that the audio information encoded into audio clip bar codes 300 is retrieved. Retrieved audio information may be played on speaker 122, or audio information may be stored in electronic format into audio data region 114 for later play back. Consequently, play back of the audio information can be effected at the same time the printed photograph image is being viewed.

In one embodiment, audio bar code logic 116 (FIG. 1) may process audio clip information signals recorded by digital camera 102 directly into printable image data. That is, digital camera 102 may generate a bar code image, or data that corresponds to an image of a bar code. When communicated to printing device 206, the printing device 206 prints the images 306 and/or 310 (FIG. 3) having the audio clip bar codes 308 and/or 312, respectively. The generated image data may be sent directly to printing device 206 when generated, or be saved into image data region 112 or another suitable memory.

In one embodiment, audio clip bar codes 300 are proprietary formatted bar codes that are generated by either audio bar code logic 116 in digital camera 102 (FIG. 1) or by audio bar code logic 236 in personal computer 202 (FIG. 2). In another embodiment, audio bar code logic 116, 236 reads formats of known bar codes.

In another embodiment, audio clip bar codes 300 may be associated with videos. For example, an audio clip barcode associated with an earlier recorded video, or a video recorded by another device, may be later recorded and printed as an audio clip bar code. Or, an audio clip bar code may be generate that is not associated with an image or video.

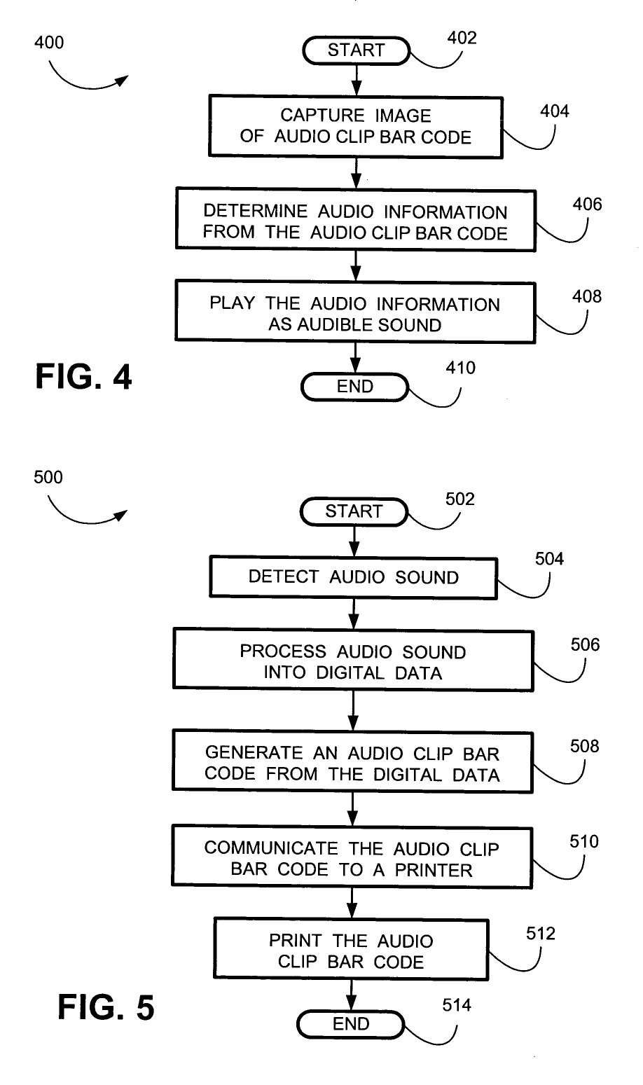

FIG. 4 is a flowchart 400 illustrating an embodiment of a process for retrieving audio information from an audio clip bar code. FIG. 5 is a flowchart 500 illustrating an embodiment of a process for generating an audio clip bar code from recorded audible sounds. The flow charts 400 and 500 show the architecture, functionality, and operation of embodiments for implementing the audio bar code logic 116 (FIG. 1).

The process of retrieving audio information from an audio clip bar code begins at step 402. At step 404, an image of an audio clip bar code is captured by digital camera 102. At step 406, audio information from the audio clip bar code 300 (FIG. 3) is determined. The audio information may be determined using any suitable system that determines audio information from images of bar codes. At step 408, audio information is played as an audible sound on speaker 122 (FIG. 1). Thus, when a visual image is viewed, the viewer may also hear the audio information broadcasted form the speaker 122 on digital camera 102 (FIG. 1). The process ends at step 410.

The process of generating an audio clip bar code from recorded audible sounds begins at step 502. At step 504, audible sound is detected. At step 506, detected audible sound is processed into digital data. At step 508, an audio clip bar code is generated from the digital data. In one embodiment, the audio clip bar code is a digitally stored image. In another embodiment, the audio clip bar code is a data file that may be used to generate an image of the audio clip bar code. At step 510, the audio clip bar code is communicated to a printer. In another embodiment, the audio clip bar code is communicated to another device, such as a personal computer or another processing system, that is in communication with a printer. At step 512 the audio bar code is printed. The process ends at step 514.

An alternative embodiment implements the logic of flow charts 400 and/or 500 with hardware configured as a state machine. In this regard, each step may represent a module, segment or portion of code, which comprises one or more executable instructions for implementing the specified logical function(s). It should also be noted that in some alternative implementations, the functions noted in the steps may occur out of the order noted in FIG. 4 or 5, or may include additional functions. For example, two steps shown in succession in FIG. 4 or 5 may in fact be substantially executed concurrently, the steps may sometimes be executed in the reverse order, or some of the steps may not be executed in all instances, depending upon the functionality involved, as will be further clarified hereinbelow. All such modifications and variations are intended to be disclosed herein.

Embodiments of the audio bar code logic 116 implemented in memory 106 (FIG. 1) may be implemented using any suitable computer-readable medium. In the context of this specification, a “computer-readable medium” can be any means that can store, communicate, propagate, or transport the data associated with, used by or in connection with the instruction execution system, apparatus, and/or device. The computer-readable medium can be, for example, but not limited to, an electronic, magnetic, optical, electromagnetic, infrared, or semiconductor system, apparatus, device, or propagation medium now known or later developed.

It should be emphasized that the above-described embodiments of the present invention, particularly, any “preferred” embodiments, are merely examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

1. A digital camera, comprising:
a photosensor to capture an image of a bar code comprising audio information;
a processor to determine audio information from the captured image of the bar code; and
a speaker to generate audible sound corresponding to the determined audio information.

2. The digital camera of claim 1, further comprising a memory wherein logic resides, the logic for determining the audio information from the captured image of the bar code when the logic is executed by the processor.

3. The digital camera of claim 1, further comprising a microphone to detect audible sound and to generate electronic information such that the processor determines a bar code corresponding to the detected audible sound.

4. The digital camera of claim 4, further comprising a memory wherein logic resides, the logic for determining the bar code corresponding to the detected audible sound when the logic is executed by the processor.

5. The digital camera of claim 4, further comprising means for communicating the bar code to a means for printing, such that the bar code is printed.

6. A method for retrieving audio information with a digital camera, the method comprising the steps of:
capturing an image of a bar code with the digital camera;
determining audio information corresponding to the captured image of the bar code with the digital camera; and
generating an audible sound corresponding to the determined audio information with an audio reproduction device residing in the digital camera.

7. The method of claim 6, further comprising the step of communicating the determined audio information to the audio reproduction device such that an audible sound corresponding to the determined audio information is generated by the audio reproduction device.

8. The method of claim 6, wherein the audio reproduction device is an electro-audio transducer.

9. The method of claim 6, wherein the audio reproduction device is a speaker.

10. The method of claim 6, wherein determining audio information further comprises the step of executing logic with a processor residing in the digital camera, the logic for determining the audio information from the captured image of the bar code when the logic is executed by the processor.

12. The method of claim 10, further comprising the step of retrieving the logic from a memory residing in the digital camera.

13. The method of claim 6, further comprising the steps of:
detecting new audio information; and
processing the detected new audio information into a new bar code.

14. The method of claim 13, further comprising the steps of:
communicating the new bar code to the printer; and
printing the new bar code.

15. The method of claim 14, further comprising the step generating a caption corresponding to the new bar code such that the caption and the new bar code are printed together.

16. The method of claim 6, wherein the step of capturing the image of the bar code further comprises capturing the image of the bar code selected from a group consisting of a one dimensional (1-D) bar code, a two dimensional (2-D) bar code and a three dimensional (3-D) bar code.

17. A system for retrieving audio information with a digital camera, comprising:
means for capturing an image of a bar code with the digital camera;
means for processing the captured image of the bar code into digital data;
means for determining audio information from the digital data; and
means for generating an audible sound corresponding to the determined audio information.

18. The system of claim 17, wherein the means for determining audio information further comprises means for executing logic, the means for executing residing in the digital camera, and the logic for determining the audio information from the captured image of the bar code when the logic is executed.

19. A computer-readable medium having a program for retrieving audio information with a digital camera, the program comprising logic to perform the steps of:
determining audio information from a captured image of a printed bar code;
communicating the determined audio information to a speaker such that an audible sound corresponding to the determined audio information is generated by the speaker.

20. The computer-readable medium of claim 19, further comprising logic for:
receiving captured image data corresponding to the bar code from a photosensor residing in the digital camera;
generating an audio signal corresponding to the audio information; and
communicating the audio signal to the speaker.

21. The computer-readable medium of claim 19, further comprising logic for capturing an image of the printed bar code.
